(19) United States
(12) Patent Application Publication
(10) Pub. No.: US 2008/0124431 A1
(43) Pub. Date: May 29, 2008

(54) HOLLOW HOT DOG

(76) Inventor: Moshe Ein-Gal, Ramat Hasharon (IL)

Correspondence Address: David Klein;DEKEL PATENT LTD., Beit HaRof'im, 18 Menuha VeNahala Street, Room 27, REHOVOT, omitted

(21) Appl. No.: 11/564,309

(22) Filed: Nov. 29, 2006

(51) Int. Cl. A23L 1/31; B65B 25/06; B65D 85/00

(52) U.S. Cl. 426/113; 426/143; 426/140; 426/129; 426/115

(57) ABSTRACT

A food product including a generally cylindrical hot dog with a hollow core formed therein, which may extend along a longitudinal axis of the hot dog.

### FIELD OF THE INVENTION

The present invention relates generally to food products, and particularly to a hot dog with a hollow core.

### BACKGROUND OF THE INVENTION

The traditional hot dog is one of the most popular foods available today. There are hundreds of different kinds of hot dogs, including traditional meat frankfurters, all beef hot dogs, chicken dogs, turkey dogs, etc. There are also numerous other types of hot dog-like food products including sausages, knockwurst, bratwurst, foot long hot dogs, veggie dogs, etc.

Another food product which is currently experiencing great popularity is referred to as a “corn dog”. A corn dog is essentially a hot dog, usually on a stick, which is dipped into or otherwise coated with a relatively thick coating of an unbaked corn meal batter on the outer surfaces of the hot dog and, thereafter, is deep fat fried. The corn meal batter is cooked in the deep fat to form a generally crunchy outer coating and a softer, corn bread like inner covering of the hot dog.

The present invention is equally applicable with respect to all such generally cylindrical food products, all of which are hereinafter referred to as “hot dogs” throughout the specification and claims. The term hot dog thus encompasses not only a standard meat, beef, chicken, turkey or other frankfurter, but also any other type of elongated meat or vegetable based food product, such as a sausage, knockwurst, bratwurst, “veggie dog” or any other similar or related product.

### SUMMARY OF THE INVENTION

The present invention seeks to provide a hot dog with a hollow core formed therein (e.g., longitudinal hollow core), as is described more in detail hereinbelow. The hollow hot dog can be filled with condiments and can be enclosed in an enclosure for comfortable and hygienic holding.

There is thus provided in accordance with an embodiment of the present invention a food product including a generally cylindrical hot dog with a hollow core formed therein. The hollow core may extend along a longitudinal axis of the hot dog.

The diameter of the hollow core transverse to the longitudinal axis may be at least half of the outer diameter of the hot dog. Alternatively, the diameter of the hollow core transverse to the longitudinal axis may be about between one-quarter and three-quarters of the outer diameter of the hot dog. Alternatively, multiple hollow cores may be provided. For example, these cores may have diameters smaller than a quarter of the outer diameter. The hollow core may be offset with respect to the longitudinal axis of the hot dog. The hollow core may have a non-straight shape, e.g. helical. The core may be “blind”, i.e., only one end is open.

In accordance with an embodiment of the present invention the hollow core may be at least partially filled with a condiment. The hot dog may be at least partially covered by an enclosure. For example, the hot dog may be hermetically sealed in the enclosure. The enclosure (e.g., sleeve) may have at least one open end, configured to allow the hot dog or contents in the hollow core to be squeezed out the open end. The enclosure may or may not be edible, and may be heated together with the hot dog in any oven, microwave oven and the like.

Factory-finished hot dogs may come with condiments inside or not. Street-prepared hot dogs may allow insertion of condiments prior to consuming. Condiments may be inserted with an injection-like process and tool. Alternatively, the condiments may be prepared and sealed in a cylindrical container rigid enough for easy insertion into the hollow bore of the hot dog. The container may be wrapped in a sealed wrapping for hygienic reasons. Prior to insertion into the hot dog, the wrapping may be removed as well as the leading container end. The container is then inserted into the hot dog and the condiments released by a combination of squeezing and/or pulling the container out.

### BRIEF DESCRIPTION OF THE DRAWINGS

The present invention will be understood and appreciated more fully from the following detailed description taken in conjunction with the drawings in which:

FIG. 1 is a simplified pictorial, partially cutaway illustration of a hot dog, constructed and operative in accordance with an embodiment of the present invention;

FIGS. 2A-2D are simplified sectional illustrations of the hot dog of FIG. 1, taken along lines II-II in FIG. 1, in accordance with different embodiments of the present invention; and

FIG. 3 is a simplified pictorial illustration of the hot dog of FIG. 1 in an enclosure, in accordance with an embodiment of the present invention.

### DETAILED DESCRIPTION OF EMBODIMENTS

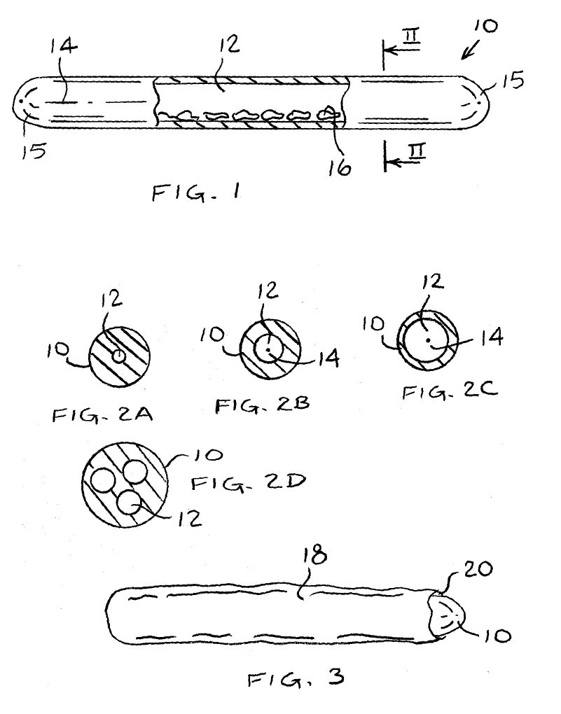

Reference is now made to FIG. 1, which illustrates a hot dog 10, constructed and operative in accordance with an embodiment of the present invention.

Hot dog 10 may be generally cylindrical and have a hollow core 12 formed therein. The hollow core 12 may extend along a longitudinal axis 14 of the hot dog 10. The hollow core 12 may be formed in any manner, such as but not limited to, preparing the hot dog in a mold with a removable cylinder corresponding to the core or by cutting out material to form the core.

As seen in FIGS. 2A-2C, the diameter of the hollow core 12 transverse to the longitudinal axis may be at least half of the outer diameter of the hot dog 10 (e.g., FIG. 2B). Alternatively, the diameter of the hollow core 12 transverse to the longitudinal axis may be about between one-quarter and three-quarters of the outer diameter of the hot dog 10 (e.g., FIGS. 2A and 2C). As seen in FIGS. 2B-2D, the hollow core 12 may be offset with respect to the longitudinal axis of the hot dog. As seen in FIG. 2D, multiple hollow cores 12 may be provided. For example, these cores may have diameters smaller than a quarter of the outer diameter of the hot dog 10. The hollow core 12 may be straight or have a non-straight shape, e.g., helical (cork screw shape). The hot dog 10 may have both ends 15 open, in which case hollow core 12 may pass through the entire length of hot dog 10 (or there may be two or more hollow cores not connected to each other, with the end cores open to the ends 15 of the hot dog 10). Alternatively, the hollow core 12 may be blind, so that hot dog 10 is open at only one end 15 and closed at the other end. Still alternatively, both ends 15 may be closed.

Referring again to FIG. 1, in accordance with an embodiment of the present invention, the hollow core 12 may be at least partially filled with a condiment 16, such as but not limited to, spices, peppers, mustard, ketchup, etc.

Reference is now made to FIG. 3. The hot dog 10 may be at least partially covered by an enclosure 18. For example, the hot dog 10 may be hermetically sealed in the enclosure 18. The enclosure 18 (e.g., sleeve) may have at least one open end 20, configured to allow the hot dog 10 or contents in the hollow core to be squeezed out the open end. The enclosure 18 may be edible (e.g., made of batter) or may be non-edible (e.g., made of a plastic), and may be heated together with the hot dog in any oven, microwave oven and the like.

Factory-finished hot dogs may come with condiments inside or not. Street-prepared hot dogs may allow insertion of condiments prior to consuming. Condiments may be inserted with an injection-like process and tool. Alternatively, the condiments may be prepared and sealed in a cylindrical container rigid enough for easy insertion into the hollow bore of the hot dog. The container may be wrapped in a sealed wrapping for hygienic reasons. Prior to insertion into the hot dog, the wrapping may be removed as well as the leading container end. The container is then inserted into the hot dog and the condiments released by a combination of squeezing and/or pulling the container out.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. A food product comprising:
a generally cylindrical hot dog with a hollow core formed therein.

2. The food product according to claim 1, wherein said hollow core extends along a longitudinal axis of said hot dog.

3. The food product according to claim 1, wherein a diameter of said hollow core transverse to the longitudinal axis is at least half of an outer diameter of said hot dog.

4. The food product according to claim 1, wherein a diameter of said hollow core transverse to the longitudinal axis is between about one-quarter and three-quarters of an outer diameter of said hot dog.

6. The food product according to claim 1, wherein said hollow core is at least partially filled with a condiment.

7. The food product according to claim 1, wherein said hot dog is at least partially covered by an enclosure.

8. The food product according to claim 7, wherein said hot dog is hermetically sealed in said enclosure.

9. The food product according to claim 7, wherein said enclosure is a sleeve having at least one open end.

10. The food product according to claim 9, wherein said sleeve is configured to allow said hot dog or contents in said hollow core to be squeezed out the open end.

11. The food product according to claim 7, wherein said enclosure is edible.

12. The food product according to claim 7, wherein said enclosure is non-edible.

13. The food product according to claim 7, wherein said enclosure is heatable together with said hot dog.

14. The food product according to claim 1, wherein said hollow core is offset with respect to the longitudinal axis of said hot dog.

15. The food product according to claim 1, comprising a plurality of hollow cores formed in said hot dog.
